(19) United States
(12) Patent Application Publication
(10) Pub. No.: US 2011/0206531 A1
(43) Pub. Date: Aug. 25, 2011

(54) EFFICIENT LOW-COST WIND ENERGY USING PASSIVE CIRCULATION CONTROL

(75) Inventors: Laurel A. Kroo, Stanford, CA (US); Ilan Kroo, Stanford, CA (US)

(73) Assignee: Desktop Aeronautics, Stanford, CA (US)

(21) Appl. No.: 13/032,545

(22) Filed: Feb. 22, 2011

Related U.S. Application Data
(60) Provisional application No. 61/306,803, filed on Feb. 22, 2010.

(51) Int. Cl. F03D 11/00

(52) U.S. Cl. 416/232

(57) ABSTRACT

Methods, systems, and apparatuses for efficient low-cost wind energy improvements using passive circulation control including, for instance, a fixed-pitch blade having a hub mountable end, a tip end, a blade body between the hub mountable end and the tip end of the fixed-pitch blade, and a channel interior to the blade body having an one or more ingress ports and one or more egress ports, according to one embodiment. For example, the one or more egress ports may be configured as a slit or a series of slits near the trailing edge so as to vent air out of the slit or slits at an angle to the local air flow traversing the blades airfoil. The one or more egress ports may be positioned longitudinally upon a top side or a bottom side of a trailing edge of the blade body such that the one or more egress ports vent air out the top or bottom side of the trailing edge of the blade body to reduce lift or increase lift respectively, for the fixed-pitch blade when under rotation upon a rotating hub via passive circulation control.

### CLAIM OF PRIORITY

This application claims the benefit of U.S. Provisional Application No. 61/306,803 filed on Feb. 22, 2010, entitled EFFICIENT LOW-COST WIND ENERGY USING PASSIVE CIRCULATION CONTROL (Attorney Docket No. 8306P002Z), the entire contents of which are incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the fluid and aerodynamics, and more particularly, to methods, systems, and apparatuses for efficient low-cost wind energy improvements using passive circulation control.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

The need to increase the operational efficiency of any electrical generation system or mechanism is unending, as is the appetite that civilization has for such energy. Increased or improved energy output from any given unit of energy input, be it fossil fuels or perceived “renewable” energy sources such as wind, hydro, thermal, solar, etc., is a goal for which a perfect 100% energy conversion solution will likely never be achieved, thus making any all improvements the more important.

The generation of electricity (e.g., the production of electrical potential) from wind power via windmills has risen to such prominence in recent years that windmills and wind farms are familiar terms to not only those concerned with such industry, but even to the consuming public. Windmills themselves date back centuries, with various levels of complexity and efficiency.

Modern windmills which produce electricity appropriate for the electrical grid must strike an appropriate balance between efficiency and complexity. For example, variable pitch blade windmills are known and common. These windmills have mechanical couplings which allow for the blades of the windmill to be rotated upon their mounting to a windmill's hub. Such rotation of the blades allows for the “pitch” of the blade to be modified during operation so as to, for example, increase or decrease the angle of attack of the blades, so as to variably control the production or absorption of power. For example, the blades can be rotated in such a way that the blades do not capture wind power, as a protection mechanism during excessive wind speeds, or the blades may be oriented so as to allow for a lower cut-in speed in low wind conditions, and yet optimized further to produce maximum energy conversion during more standard wind speed conditions. Similar theory applies to propeller blades, hydropower blades, etc.

The ability to variably control the pitch of such blades comes with a cost. Variable control mechanisms introduce numerous moving parts and additional complexity. These moving parts are not only more expensive to produce initially, but carry with them increased maintenance costs over the life of a system utilizing such variable pitch control mechanisms.

Other less complex mechanisms have been contemplated in effort to capture efficiency improvements (e.g., more efficient capture of wind energy) including flaps on the trailing edges of wind blades, but such flaps are still moving parts, and thus, are more prone to damage and wear in contrast to non-movable parts, and thus carry with them their own maintenance burden.

While the use of renewable energy sources in the production of electricity is, in of itself, an admirable goal, the realities which drive development, deployment, and adoption of such technologies are inextricably linked to economics. Therefore, the manufacturing, deployment (e.g., installation), and especially maintenance costs of production windmills is of extreme importance to the operators of such systems. In particular, a feasibility study for a wind farm must first demonstrate that it can generate sufficient revenue from electrical power production over time so as to recoup not only the cost of manufacturing and installing the actual wind energy capturing mechanisms, but also the costs associated with maintenance over the life of the system, and presumably produce sufficient profits. The increased complexity of variable pitch control systems increases the maintenance costs of such systems, which in turn reduces the overall feasibility of such systems, by making the return on investment less favorable than what it may be on other sources of energy, such as non-renewable sources.

A less complex system which nevertheless exhibits improved efficiency is needed. The present state of the art may benefit from the methods, systems, and apparatuses for efficient low-cost wind energy improvements using passive circulation control described herein.

### BRIEF DESCRIPTION OF THE DRAWINGS

Embodiments of the present invention are illustrated by way of example, and not by way of limitation, and can be more fully understood with reference to the following detailed description when considered in connection with the figures in which:

FIG. 1 illustrates an exemplary fixed-pitch blade structure in accordance with disclosed embodiments;

FIG. 2 illustrates an alternative exemplary fixed-pitch blade structure in accordance with disclosed embodiments;

FIG. 3 illustrates an alternative exemplary fixed-pitch blade structure in accordance with disclosed embodiments;

FIG. 4 depicts various components relevant to passive circulation control equations; and

FIG. 5 illustrates an exemplary windmill having a plurality of fixed-pitch blades in accordance with disclosed embodiments.

### DETAILED DESCRIPTION

Described herein are methods, systems, and apparatuses for efficient low-cost wind energy improvements using passive circulation control. For instance, the systems, apparatuses, and methods include a fixed-pitch blade having a hub mountable end, a tip end, a blade body between the hub mountable end and the tip end of the fixed-pitch blade, and a channel interior to the blade body having one or more ingress ports and one or more egress ports, according to one embodiment. For example, the one or more egress ports may configured as a long slit near the trailing edge or a series of slits near the trailing edge, such that air is vented out the slit or slits so as to disrupt the local airflow, as is described in additional detail below. The one or more egress ports may be positioned longitudinally near a top side or a bottom side of a trailing edge of the blade body such that the one or more egress ports vent air out the top or bottom side of the trailing edge of the blade body to reduce lift or increase lift respectively, for the fixed-pitch blade when under rotation upon a rotating hub. In such a configuration, centrifugal force propels the air from the one or more ingress ports to the one or more egress ports, where the air is vented out, thus resulting in passive circulation control as described herein. Passive circulation control may also be referred to as passive flow control.

The above described fixed-pitch blade will exhibit passive circulation control to effect a net change upon lift (e.g., an increase or decrease as described) when deployed within alternative fluid environments, such as upon a hydro power mill deployed in, for example, a river or a marine environment, so as to capture kinetic energy from surrounding river water or marine tidal flows, respectively. Similarly, a fixed-pitch blade as described above may be employed upon a fixed pitch airplane propeller, so as to improve the overall efficiency of such a propeller (e.g., configured to increase lift of the propeller blades) without necessitating the complexity of variable pitch control systems.

A windmill system may employ a plurality of such fixed-pitch blades so as to benefit from the efficiency gains derived from passive circulation control of its blades without the complexity of a variable pitch control mechanism.

Passive circulation control as described herein allows one to realize a net change in lift upon a fixed-pitch blade which changes in relation to rotational speed of the blades upon a rotating hub, thus enabling efficiency gains or other desirable changes to operating characteristics without the necessity for a variable pitch control mechanism. Because there are no moving parts required with passive circulation control as described, the resulting passive system yields a more robust, less complex solution.

The net effect of passive circulation control is tied to the speed of the rotating blades, or the speed of any individual rotating blade having the passive circulation control mechanism embodied therein. Control is “automatic” in the sense that no active system is required to cause the changes to lift upon the blades as described. With conventional airfoils and blades, be they aircraft wings, windmill blades, or blades on a hydropower turbine, conventional movable flaps on a trailing edge effects a change upon the entire flow field around the blade, airfoil, etc. With passive circulation control, the change in lift is mostly attributable to the modified airflow around the blade or airfoil as a result of the expelled air via the passive circulation control, rather than a reactionary change owing to the force with which the air is expelled from the blade or airfoil. This concept is described in more detail below with reference to applicable equations.

Moreover, the net change upon lift for a blade operates in relation to its rotational speed. As the rotor speed increases, causing the forces (centrifugal force) due to rotation to increase, pressure increases, resulting in the flow and velocity of air through the blade to increase. However, the result is not strictly linear. As the blades spin faster, other losses are incurred, reducing the effect. This non-linear change can be advantageous in configurations, in accordance with embodiments described herein.

In the following description, numerous specific details are set forth such as examples of specific systems, materials, formulaic equations, components, etc., in order to provide a thorough understanding of the various embodiments. It will be apparent, however, to one skilled in the art that these specific details need not be employed to practice the disclosed embodiments. In other instances, well known materials, equations, or methods have not been described in detail in order to avoid unnecessarily obscuring the disclosed embodiments.

Embodiments also relate to a system or apparatus for performing certain operations disclosed herein, including performing methods using the disclosed systems and apparatuses. The disclosed systems or apparatuses may be specially constructed for the required purposes, or they may comprise general purpose components and materials selectively reconfigured or repurposed in the manner understood by those having skill in the relevant arts.

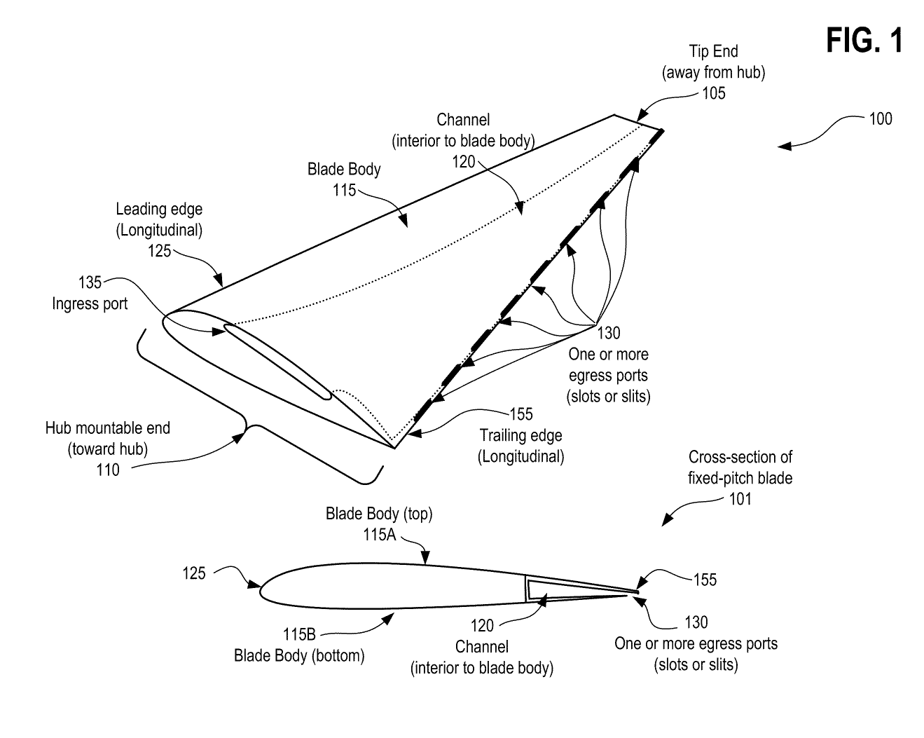

FIG. 1 illustrates an exemplary fixed-pitch blade structure 100 in accordance with disclosed embodiments. The fixed-pitch blade structure 100 depicts a hub mountable end 110 and a tip end 105. When mounted to a rotatable hub, the hub-mountable end 110 is positioned toward such a hub, and the tip end 105 is positioned laterally opposite, away from the hub. A blade body 115 is depicted as being between the hub mountable end 110 and the tip end 105 of the fixed-pitch blade structure 100. A channel 120 is further depicted interior to the blade body 115. The channel has, or is connected with, an ingress port 135 and one or more egress ports 130 as shown.

In one embodiment, the blade body has a leading edge 125 and a trailing edge 155, each longitudinal upon the length of the blade body 115. When rotating upon a rotatable hub, the leading edge 125 of the blade body rotates into the surrounding fluid medium, be it ambient air, water, or otherwise. The trailing edge 155 follows the rotation of the blade body 115. The leading edge 125 of the blade body may form the curved face of an airfoil.

In one embodiment, the fixed-pitch blade structure 100 constitutes a hollow wind turbine blade which ducts air from the root (the portion of the blade near the hub at hub mountable end 110) and out the trailing edge of the blade (e.g., along trailing edge 155) using centrifugal force. By “blowing” air out of the back upper or lower surfaces of an airfoil, the blade's lift is changed. For example, air may be blown, jettisoned, vented, etc., from the trailing edge 155 of the fixed-pitch blade structure 100. Refer to element 155 of the cross-section of the fixed pitch blade 101 depicting a trailing edge. Air may be blown, jettisoned, or vented at the trailing edge 155 along a top side of the blade body 115A or along a bottom side of the blade body 115B so as to achieve the desired effect. For example, the air is vented at an angle to the local flow so as to cause a change or modification to the local flow traversing the air foil at or near the trailing edge, thus resulting to the desired change in lift (e.g., rather than blowing the air straight out the trailing edge in the direction of the local flow traversing the airfoil). Thus, in accordance with one embodiment, the one or more egress ports 130 are positioned longitudinally near the trailing edge of the blade body. In one embodiment, the one or more egress 130 near the trailing edge vent air out of the blade body at an angle to the local flow traversing the airfoil.

Blowing air out of an airfoil, wing, fixed-pitch blade structure 100, etc., may be referred to as “flow control” or “circulation control.” However, passive circulation control as described herein effectuates the blowing, venting, or jettison of air or other fluid without the use of an active system, such as an air compressor or a reserve of compressed air. Pressurized air blown out of one or more slots or vents, such as the one or more egress ports 130 depicted, along a trailing edge 155 may serve to increase the lift. Such a configuration in an aircraft wing may aid in preventing stall or reducing the stall speed at which the wing fails to produce sufficient lift. In accordance with the disclosed embodiments, the fixed-pitch blade structure 100 depicted forms any one of: an airfoil; a windmill blade; a hydrofoil blade; or a propeller blade.

As applied to wind turbine rotors and blades (e.g., fixed-pitch blade structure 100), lift has a component of force in the direction of the blade's motion. Changing the lift results in a change to torque energy received at the wind turbine's rotor and blades, allowing for a complimentary change to rotational speed, or power output, or both, for the wind turbine and its generator. The passive circulation control systems, mechanisms, apparatuses, and processes as described herein require no pressurized gas or active sensing mechanisms. That is, they are entirely passive.

In a particular embodiment, a fixed-pitch blade structure 100 includes a hub mountable end 110, a tip end 105, a blade body 115 between the hub mountable end 110 and the tip end 105 of the fixed-pitch blade structure 100, means for ingres sing ambient air substantially near the hub mountable end 110, means for dispersing air to one or more egress ports 130 longitudinally positioned upon a trailing edge 155 of the blade body 115 of the fixed-pitch blade structure 100, and means for centrifugally ejecting the dispersed air out the one or more egress ports 130 to effect a net change in lift upon the fixed-pitch blade structure 100 when under rotation upon a rotating hub.

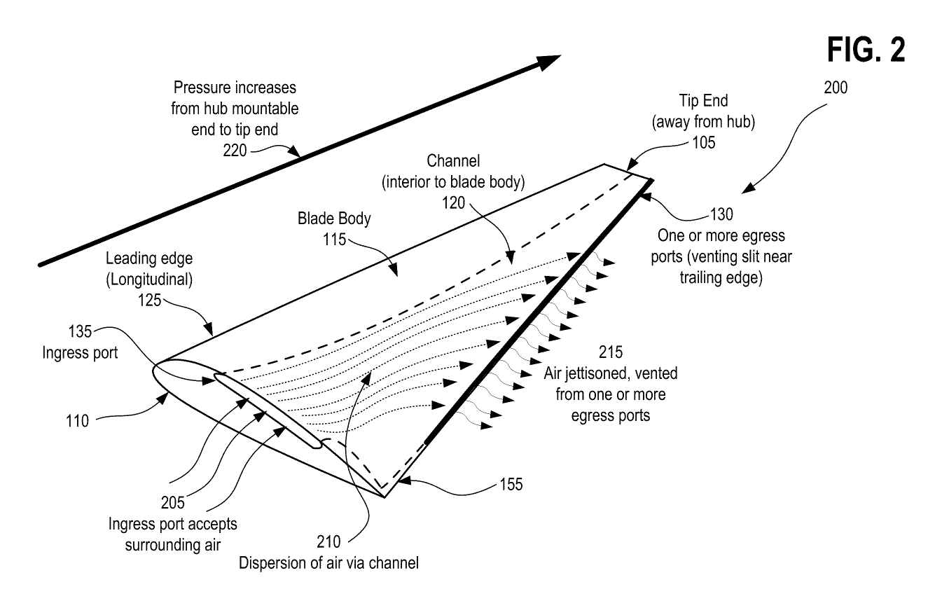

FIG. 2 illustrates an alternative exemplary fixed-pitch blade structure 200 in accordance with disclosed embodiments. More particularly, fluid flows, and specifically air flow is depicted in relation to the fixed-pitch blade structure 200.

In one embodiment, the ingress port 135 is to accept air surrounding the ingress port 135 into the channel at a first air pressure. As depicted by the upwardly pointing left to right arrow at 220, pressure increases from the hub mountable end 110, nearest a hub to the tip end 105, furthest from a hub. In such an embodiment, the channel 120 interior to the blade body is to disperse the air in the direction of the one or more egress ports under centrifugal force in proportion to a rotational speed of the fixed-pitch blade upon a rotating hub. For example, refer to element 205 depicting the ingress port accepting surrounding air, element 210 depicting the dispersion of the air via the channel, and element 215 depicting the air being jettisoned, vented, or blown from one or more egress ports. In such an embodiment, the one or more egress ports jettison the air from the channel of the blade body at a second air pressure which is greater than the first air pressure at which the air is accepted into the ingress port at element 205.

In accordance with one embodiment, the air jettisoned from the channel of the blade body via the one or more egress ports as depicted at element 215 has an effect upon lift of the fixed-pitch blade which is in relation to the rotational speed of the fixed-pitch blade upon a rotating hub.

In one embodiment, centrifugal force upon the blade body (e.g., fixed-pitch blade structure 100) under rotation causes surrounding air to enter the ingress port 205, traverse the channel 210, and exit the one or more egress ports 215 as shown.

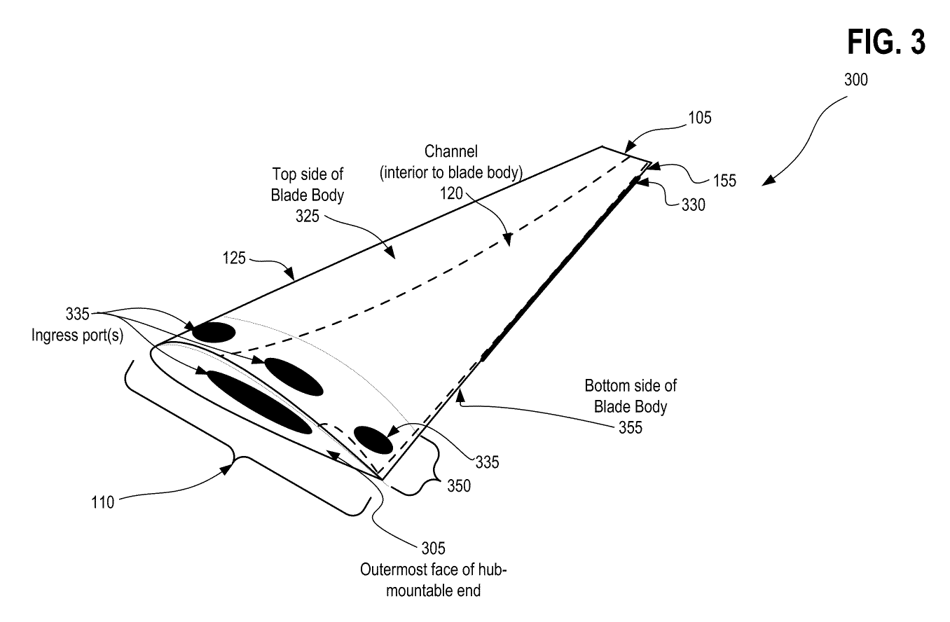

FIG. 3 illustrates an alternative exemplary fixed-pitch blade structure 300 in accordance with disclosed embodiments. More particularly, alternative ingress port(s) 335 and egress port(s) 330 are depicted.

The fixed-pitch blade structure 300 may have more than one ingress port 335, though only one is required. The ingress ports 335 may also be positioned in any of several alternative locations upon the blade. In one embodiment, an ingress port 335 is positioned at any one of: an outermost face 305 of the hub-mountable end; within a top side of the blade body 325 substantially toward the hub mountable end 110 of the fixed-pitch blade 300; within a bottom side of the blade body 355 substantially toward the hub mountable end 110 of the fixed-pitch blade 300; within, at, or near a leading edge 125 of the blade body substantially toward the hub mountable end 110 of the fixed-pitch blade 300; or within a trailing edge 155 of the blade body substantially toward the hub mountable end 110 of the fixed-pitch blade 300.

In some embodiments, the fixed-pitch blade 300 may further include a structural connecting member which connects the blade body with the hub-mountable end. Such a portion of the fixed-pitch blade structure 300 may or may not contribute as a lifting surface for the fixed-pitch blade structure 300. For example, refer to the portion of the fixed-pitch blade structure 300 identified by element 350, near the hub mountable end 110. Nevertheless, one or more ingress ports 335 may be located in a structural connecting member portion 350 of the fixed-pitch blade structure 300. When the ingress port 335 is positioned within the outermost face 305 of the hub-mountable end 110, the ingress port 335 may be configured to couple with and accept air into the fixed-pitch blade structure 300 from a hub, when the blade is mounted to a hub. In such an embodiment, an ingress port may be located within the hub with a connecting channel between the ingress port of the hub to the ingress port 335 of the blade structure at the outermost face 305.

The one or more egress ports 330 may take various forms to achieve the desired effect upon lift. In one embodiment, the one or more egress ports 330 are positioned longitudinally near the trailing edge 155 of the blade body. For instance, element 330 depicts a venting slit positioned longitudinally near the trailing edge 155 of the blade body. Alternatively, multiple venting slits may be positioned longitudinally near the trailing edge 155 of the blade body, such as those depicted at element 130 of FIG. 1.

In one embodiment, the one or more egress ports (e.g., 130 and/or 330) are positioned longitudinally upon a top side of a trailing edge of the blade body. In such a configuration, the one or more egress ports are to vent air out the top side of the trailing edge of the blade body to reduce or decrease lift of the fixed-pitch blade when under rotation upon a rotating hub. In an alternative embodiment, the one or more egress ports (e.g., 130 and/or 330) are positioned longitudinally upon a bottom side of a trailing edge of the blade body in which the one or more egress ports are to vent air out the bottom side of the trailing edge of the blade body to increase lift of the fixed-pitch blade when under rotation upon a rotating hub.

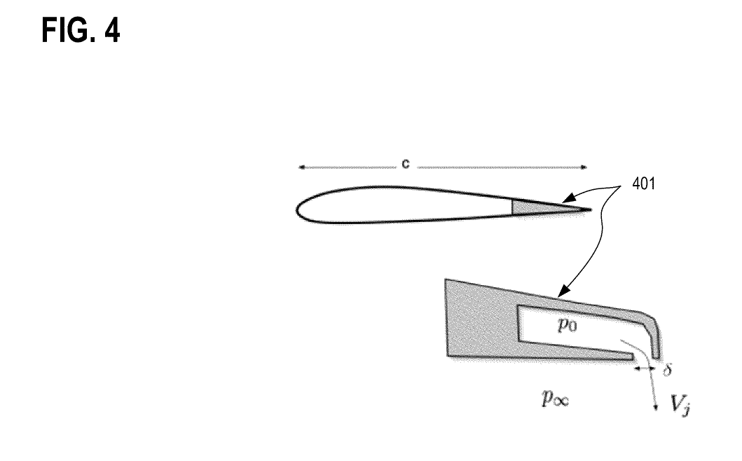

FIG. 4 depicts various components relevant to passive circulation control equations. More particularly, FIG. 4 depicts a two-dimensional blade cross section. The shaded region at element 401 illustrates one embodiment of a venting slot or egress port for such a blade. As shown, c is the blade's chord, p₀ is the pressure within the internal channel (e.g., 120) anywhere along the blade, p_{∞} is the ambient static pressure, delta is the venting slot/egress port width, and Vⱼ is the average fluid velocity coming out of the venting slot/egress port.

Slot geometry (e.g., size and shape of the one or more slits, slots, or egress ports 130) affects the lift coefficient. Assume that the momentum coefficient is defined as (equation 1.1):

$${C}_{μ} = \frac{ρ {V}_{j}^{2} δ}{.5 ρ {V}^{2} c}$$

Where ρ is the fluid density, Vⱼ is the jet velocity, V is the local velocity, δ is the venting slot/egress port width, and c is the blade chord. One can solve for venting slot/egress port width. Using Computational fluid dynamics (CFD) codes, one may compute lift as a function of the momentum coefficient and blade geometry. By varying the above parameter Cμ, one can change the lift, for example, as predicted by CFD analysis. For example, one may vary the slot width to vary Cμ and the desired lift.

CFD results reflect that changing the momentum coefficient (Cmu) apparently changes the angle of attack at any given lift coefficient. With CFD results, passive circulation control can be understood with respect to variable pitch control where, for example, for a fixed pitch (say 4 degrees angle of attack) and momentum coefficient, passive circulation control will increase the lift coefficient by about 1. This is equivalent to physically changing the pitch angle of the blade (as in a variable pitch system) by 6 degrees. These results provide correlation between the geometry and the passive circulation control system behavior.

Various blade designs are therefore available to achieve a desired effect. For instance, one may shift the cl to increase the range of wind speeds at which a fixed-pitch turbine, such as a windmill having fixed-pitch blades, may operate, thus increasing the total average power over time. Turbines (such as windmills) have a cut-in speed. The cut-in speed is a wind speed at which the rotor provides sufficient torque on the generator shaft to produce minimum power. Turbines also have a cut-out speed, where the rotational speed approaches a point that may damage the turbine, such as stripping the gears within a turbine's generator. Turbines therefore employ various protection mechanisms to protect the turbine from damaging itself at high angular speeds (e.g., such as a locking mechanism, or a mechanism to turn out of the wind).

For a fixed pitch turbine, the cut-in speed and cut-out speed are closely correlated. A rotor with large surface area and shallow incidence distribution (designed for low cut-in speeds) will have low cut-out speeds; that is, it will reach the maximum rpm for the generator quickly. The reverse is also true. A rotor designed to cut in at relatively higher wind speeds will be able to operate at very high wind speeds without damaging the generator, but may produce no power in normal conditions, should normal conditions constitute wind speeds below the cut-in speed for the turbine.

Passive circulation control can be used in conjunction with blade design to increase the operable range at which the rotor (e.g., a hub having fixed-pitch blades as described herein) can produce power. For example, a blade designed for a lower cut-in speed in conjunction with passive circulation control as described herein can decrease the lift (and hence, the rpm) at higher wind speeds. Decreasing the lift and rpm at higher wind speeds expands the operational envelope or operational range for such a turbine, thus resulting in higher average power output (e.g., electrical power generation) over time.

Where passive circulation control is implemented to decrease the lift coefficient, the one or more venting slots or egress ports may be positioned on the upper lip of the trailing edge of the blade, thus creating regions of high pressure or separation on the upper lip of the trailing edge, resulting in a decrease in lift.

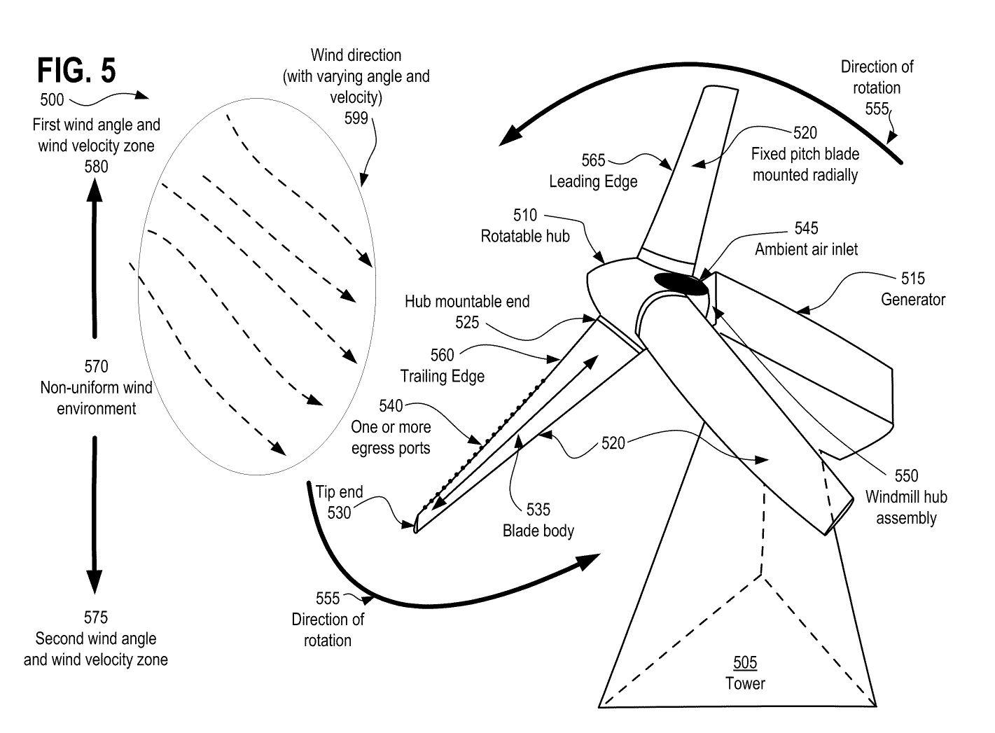

FIG. 5 illustrates an exemplary windmill 500 having a plurality of fixed-pitch blades 520 in accordance with disclosed embodiments. In one embodiment, the windmill 500 includes a tower 505, a windmill hub assembly 550 mounted upon the tower 505, the windmill hub assembly 550 having a rotatable hub 510 and a generator 515 to convert kinetic energy from the rotatable hub 510 into electrical potential, and a plurality of fixed-pitch blades 520 mounted radially upon the rotatable hub 510. Element 599 depicts the general wind direction, having varying angles and velocity throughout the non-uniform wind environment. The direction of rotation 555 is also depicted for reference relative to leading and trailing edges of the depicted blades 520.

In such an embodiment, each of the plurality of fixed-pitch blades 520 include a hub mountable end 525 fixedly attached to the rotatable hub 510, a tip end 530, a blade body 535 between the hub mountable end 525 and the tip end 530 of the fixed-pitch blade 520, and a channel interior to the blade body 535 having an ingress port and one or more egress ports 540. For example, in one embodiment the channel interior to the blade body 535 includes a channel such as that depicted at element 120 of FIG. 1. In one embodiment, each of the plurality of fixed pitch blades 520 radially mounted upon the rotatable hub 510 are equivalent to those depicted at structure 100 of FIG. 1.

In one embodiment, the ingress port corresponds to one of those as depicted at element 335 of FIG. 3. In one embodiment, each of the plurality of fixed-pitch blades mounted radially upon the rotatable hub has its respective ingress port positioned: within a structural connecting member of the respective fixed-pitch blade, wherein the structural connecting member connects the blade body with the hub-mountable end; within a top side of the blade body 535 substantially toward the hub mountable end 525 of the respective fixed-pitch blade 520; within a bottom side of the blade body 535 substantially toward the hub mountable end 525 of the respective fixed-pitch blade 520; within a leading edge 565 of the blade body 535 substantially toward the hub mountable end 525 of the respective fixed-pitch blade 520; or within a trailing edge 560 of the blade body 535 substantially toward the hub mountable end 525 of the respective fixed-pitch blade 520.

In an alternative embodiment, the windmill hub assembly 550 further includes an ambient air inlet 545, wherein the ingress port of each of the plurality of fixed-pitch blades 520 mounted radially upon the rotatable hub is connected with the ambient air inlet 545 of the windmill hub assembly 550 via a hub air channel. Such an ambient air inlet 545 may be positioned upon the rotatable hub 510 itself, as depicted, or upon the generator 515 body, or elsewhere, such that ambient air may flow into the respective ingress ports of the radially mounted fixed-pitch blades upon the rotatable hub 510.

In one embodiment, the one or more egress ports 540 (e.g., slits, slots, venting slits, etc.) of each respective fixed-pitch blade mounted radially upon the rotatable hub are positioned longitudinally upon a top side of a trailing edge of the blade body for the respective fixed-pitch blade and the one or more egress ports 540 vent air out the top side of the trailing edge 560 of the blade body 535 to reduce lift of the respective fixed-pitch blade 520 when under rotation upon the rotatable hub 510. In such an embodiment, the decrease in lift correlates to an increased operational wind speed range for the windmill 500 as defined by a difference between a cut-in speed and a cut-out speed for the windmill.

In one embodiment, the plurality of fixed-pitch blades 520 mounted radially upon the rotatable hub 510 traverse a non-uniform wind environment 570 when rotating upon the rotatable hub 510 and lift is decreased for any one or more of the plurality of fixed-pitch blades 520 traversing a first wind angle and wind velocity zone 580 of the non-uniform wind environment 570 to an amount greater than or lesser than any one or more of the remaining plurality of fixed-pitch blades 520 traversing second wind angle and wind velocity zone 575 of the non-uniform wind environment 570.

Vⱼ is a function of the local flow environment, and is thus affected by differing wind angles and wind velocities. Therefore, Vⱼ will be different for a blade traversing through a first wind angle and wind velocity zone 580 than Vⱼ for a blade traversing through a second wind angle and wind velocity zone 580, when the velocity and angle of the wind in each respective zone is distinct. When deployed, windmills operate in an environment that has non-uniform wind (e.g., environment 570), and thus, as the blades of the windmill traverse through the various portions of such a non-uniform wind environment 570, the blades are affected by differing wind velocities and wind angles in the various portions of the environment, and thus, Vⱼ will be different for each of the blades, even when the blades themselves are otherwise identical.

In an orientation to reduce lift at greater rotational speeds (in rpm), Vⱼ will also cause the fixed pitch blades 520 to reduce lift upon those fixed pitch blades 520 traversing a locally higher energy environment owing to differing wind velocities and angles upon the blades, in comparison to those fixed pitch blades 520 traversing a lower energy environment at any particular blade 520. Azimuthal control relates to the ability to decrease blade stress and smooth the rotation of blades through non-uniform wind environments 570. Material Fatigue is incurred from back and forth stresses upon the rotating blade(s) 520 and rotatable hub 510 mechanism traversing through zones having differing wind angles and velocities. Though material fatigue may be mitigated by employing more tolerant materials, blade stress nevertheless exerts fatigue upon all materials and therefore reduces the useful life of the windmill 500 and/or its constituent parts (e.g., the blades 520).

Therefore, in accordance with one embodiment, the decreased lift for the one or more of the plurality of fixed-pitch blades 520 traversing the second wind angle and velocity zone 580 of the non-uniform wind environment 570 correlates to a reduction in blade stress upon the windmill 500.

In one embodiment, the one or more egress ports 540 of each respective fixed-pitch blade 520 mounted radially upon the rotatable hub 510 are positioned longitudinally upon a bottom side of a trailing edge 560 of the blade body 535 for the respective fixed-pitch blade 520 and the one or more egress ports 540 are to vent air out the bottom side of the trailing edge 560 of the blade body to increase lift of the respective fixed-pitch blade 520 when under rotation upon the rotatable hub 510, wherein the increase in lift correlates to an increase in a total amount of kinetic energy converted from the rotatable hub 510 for a given rotational speed of the rotatable hub 510.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A fixed-pitch blade comprising:
a hub mountable end;
a tip end;
a blade body between the hub mountable end and the tip end of the fixed-pitch blade; and
a channel interior to the blade body having one or more ingress ports and one or more egress ports, the one or more egress ports near a trailing edge of the blade body.

2. The fixed-pitch blade of claim 1:
wherein the blade body comprises a leading edge and the trailing edge, each longitudinal upon the length of the blade body; and
wherein the one or more egress ports are positioned longitudinally near or substantially at the trailing edge of the blade body.

3. The fixed-pitch blade of claim 2, wherein the one or more egress ports comprise a series of venting slits positioned longitudinally near the trailing edge of the blade body.

4. The fixed-pitch blade of claim 2, wherein the one or more egress ports comprise a lengthwise venting slit positioned longitudinally near the trailing edge of the blade body.

5. The fixed-pitch blade of claim 1:
wherein the one or more egress ports are positioned longitudinally upon a top side of a trailing edge of the blade body; and
wherein the one or more egress ports are to vent air out the top side of the trailing edge of the blade body to reduce lift of the fixed-pitch blade when under rotation upon a rotating hub.

6. The fixed-pitch blade of claim 1:
wherein the one or more egress ports are positioned longitudinally upon a bottom side of a trailing edge of the blade body; and
wherein the one or more egress ports are to vent air out the bottom side of the trailing edge of the blade body to increase lift of the fixed-pitch blade when under rotation upon a rotating hub.

7. The fixed-pitch blade of claim 1:
wherein the ingress port is to accept air surrounding the ingress port into the channel at a first air pressure;
wherein the channel to disperse the air in the direction of the one or more egress ports under centrifugal force in proportion to a rotational speed of the fixed-pitch blade upon a rotating hub; and
wherein the one or more egress ports to jettison the air from the channel of the blade body at a second air pressure which is greater than the first air pressure.

8. The fixed-pitch blade of claim 7, wherein the air jettisoned from the channel of the blade body via the one or more egress ports has an effect upon lift of the fixed-pitch blade which is in relation to the rotational speed of the fixed-pitch blade upon a rotating hub.

9. The fixed-pitch blade of claim 1, wherein centrifugal force upon the blade body under rotation causes surrounding air to enter the ingress port, traverse the channel, and exit the one or more egress ports.

10. The fixed-pitch blade of claim 1, wherein the ingress port is positioned at one of:
an outermost face of the hub-mountable end;
within a structural connecting member of the fixed-pitch blade, wherein the structural connecting member connects the blade body with the hub-mountable end;
within a top side of the blade body substantially toward the hub mountable end of the fixed-pitch blade;
within a bottom side of the blade body substantially toward the hub mountable end of the fixed-pitch blade;
within a leading edge of the blade body substantially toward the hub mountable end of the fixed-pitch blade; and
within a trailing edge of the blade body substantially toward the hub mountable end of the fixed-pitch blade.

11. The fixed-pitch blade of claim 1, wherein the fixed-pitch blade forms one of:
an airfoil;
a windmill blade;
a hydrofoil blade; and
a propeller blade.

12. A windmill comprising:
a tower;
a windmill hub assembly mounted upon the tower and having a rotating hub and a generator to convert kinetic energy from the rotatable hub into electrical potential; and
a plurality of fixed-pitch blades mounted radially upon the rotatable hub, each of the plurality of fixed-pitch blades comprising:
a hub mountable end fixedly attached to the rotatable hub,
a tip end,
a blade body between the hub mountable end and the tip end of the fixed-pitch blade, and
a channel interior to the blade body having an ingress port and one or more egress ports, the one or more egress ports near a trailing edge of the blade body.

13. The windmill of claim 12, wherein the windmill hub assembly further comprises an ambient air inlet, and wherein the ingress port of each of the plurality of fixed-pitch blades mounted radially upon the rotatable hub is connected with the ambient air inlet of the windmill hub assembly via a hub air channel.

14. The windmill of claim 12, wherein each of the plurality of fixed-pitch blades mounted radially upon the rotatable hub has its respective ingress port positioned at one of:
within a structural connecting member of the respective fixed-pitch blade, wherein the structural connecting member connects the blade body with the hub-mountable end;
within a top side of the blade body substantially toward the hub mountable end of the respective fixed-pitch blade;
within a bottom side of the blade body substantially toward the hub mountable end of the respective fixed-pitch blade;
within a leading edge of the blade body substantially toward the hub mountable end of the respective fixed-pitch blade; and
within the trailing edge of the blade body substantially toward the hub mountable end of the respective fixed-pitch blade.

15. The windmill of claim 12:
wherein the one or more egress ports of each respective fixed-pitch blade mounted radially upon the rotatable hub are positioned longitudinally upon a top side of the trailing edge of the blade body for the respective fixed-pitch blade; and
wherein the one or more egress ports are to vent air out the top side of the trailing edge of the blade body to reduce lift of the respective fixed-pitch blade when under rotation upon the rotatable hub.

16. The windmill of claim 15, wherein the decrease in lift correlates to an increased operational wind speed range for the windmill as defined by a difference between a cut-in speed and a cut-out speed for the windmill.

17. The windmill of claim 15:
wherein the plurality of fixed-pitch blades mounted radially upon the rotatable hub traverse a non-uniform wind environment when rotating upon the rotatable hub; and
wherein lift is decreased for any one or more of the plurality of fixed-pitch blades traversing a first wind angle and wind velocity zone of the non-uniform wind environment to an amount greater than any one or more of the remaining plurality of fixed-pitch blades traversing a second wind angle and wind velocity zone of the non-uniform wind environment.

18. The windmill of claim 16, wherein the decreased lift for the one or more of the plurality of fixed-pitch blades traversing the second wind angle and velocity zone of the non-uniform wind environment correlates to a reduction in blade stress upon the windmill.

19. The windmill of claim 12:
wherein the one or more egress ports of each respective fixed-pitch blade mounted radially upon the rotatable hub are positioned longitudinally upon a bottom side of the trailing edge of the blade body for the respective fixed-pitch blade; and
wherein the one or more egress ports are to vent air out the bottom side of the trailing edge of the blade body to increase lift of the respective fixed-pitch blade when under rotation upon the rotatable hub, wherein the increase in lift correlates to an increase in a total amount of kinetic energy converted from the rotatable hub for a given rotational speed of the rotatable hub.

20. A fixed-pitch blade comprising:
a hub mountable end;
a tip end;
a blade body between the hub mountable end and the tip end of the fixed-pitch blade; and
means for ingressing ambient air substantially near the hub mountable end;
means for dispersing air to one or more egress ports longitudinally positioned upon a trailing edge of the blade body of the fixed-pitch blade; and
means for centrifugally ejecting the dispersed air out the one or more egress ports near the trailing edge of the blade body at an angle to a local flow traversing an airfoil of the fixed-pitch blade to effect a net change in lift upon the fixed-pitch blade when under rotation upon a rotating hub.
